(19) United States
(12) Patent Application Publication
(10) Pub. No.: US 2012/0030739 A1
(43) Pub. Date: Feb. 2, 2012

(54) METHOD AND APPARATUS FOR SECURITY OF MEDIUM INDEPENDENT HANDOVER MESSAGE TRANSMISSION

(75) Inventors: Murahari Vadapalli, Suwon city (KR); Jeong Jae Won, Gyeonggi-do (KR); Young Seok Kim, Gyeonggi-do (KR)

(73) Assignee: SAMSUNG ELECTRONICS CO., LTD., Suwon-city, Gyeonggi-do (KR)

(21) Appl. No.: 13/142,028

(22) PCT Filed: Dec. 24, 2009
(86) PCT No.: PCT/KR2009/007758

§ 371 Date: Sep. 19, 2011

(30) Foreign Application Priority Data
Dec. 24, 2008 (KR) 10-2008-0132912

(51) Int. Cl. G06F 21/20

(52) U.S. Cl. 726/6

(57) ABSTRACT

A method and an apparatus for securing media independent handover message transportation are provided. The method for securing media independent handover message transportation, include: performing an authentication procedure by a terminal with an access router to generate a master session key; transmitting the generated master session key and address information of the terminal to an information server by the access router; generating an information server key to be used in transmitting and receiving a message by the information server with the terminal using the received master session key and the address information of the terminal; and forming a secure channel by the terminal and the information server using the generated information server key. Since a key formed at a layer 2 is used in an MIH authentication step being a layer 3 not to repeatedly create a secure key, a security procedure may be rapidly performed.

### BACKGROUND OF THE INVENTION

1. Field of the Invention

The present invention relates to a method and an apparatus for securing media independent handover (referred to as ‘MIH’ hereinafter) message transportation, and more particularly, to a method for securing MIH message transportation of forming a secure channel using a security protocol such as IPSec, DTLS, or MIHSec according to the present invention and then transporting an MIH message, and an apparatus performing the same.

2. Description of the Related Art

An 802.21 working group has been organized to support Seamless handover between Heterogeneous Networks. The working group denominated handover between Heterogeneous Networks as ‘MIH’.

The MIH considers a multi-mode terminal including a network connection interface with at least two different characteristics. A type of the interface includes a wired interface type such as IEEE802.3 based Ethernet, a wireless interface type based on IEEE802.XX such as IEEE802.11, IEEE802.15, IEEE802.16, or an interface type defined in a cellular standard organization such as 3GPP, 3GPP2.

A goal of a seamless mobility service provided through MIH technology enables a terminal to satisfy a service level received from a previous network to the highest degree to secure service quality when the terminal performs a handover between Heterogeneous Networks.

To do this, the working group denominates a Media Independent Handover Function (referred to as ‘MIHF’ hereinafter) as a function entity for implementing the MIH technology. The MIHF is a function entity located at an intermediate level between a protocol, application or management function pertaining to a layer 3 or more and a device driver pertaining to a layer 2 or less. The MIHF may transfer network state information generated by a lower device driver to an upper layer (e.g., mobility management protocol) that causes the upper layer to optimize performance according to mobility processing in a layer IP or more.

However, in order to perform the handover between Heterogeneous Networks, an MIH message exchanging between MIHFs of respective networks is transmitted and received through a non-secure channel.

Accordingly, there is a need to form a secure channel between an MIHF of a terminal and an MIHF of an entity transmitting and receiving an MIH message when transmitting the MIH message.

### SUMMARY OF THE INVENTION

The present invention has been made in view of the above problems, and provides a method for forming a secure channel between an MIHF of a terminal and an MIHF of an entity transmitting and receiving an MIH message when transmitting the MIH message, and an apparatus thereof.

To do this, the present invention forms a secure channel using a security protocol such as IPSec, DTLS, or MIHS according to the present invention.

In accordance with an aspect of the present invention, a method for securing media independent handover message transportation, includes: performing an authentication procedure by a terminal with an access router to generate a master session key; transmitting the generated master session key and address information of the terminal to an information server by the access router; generating an information server key to be used in transmitting and receiving a message by the information server with the terminal using the received master session key and the address information of the terminal; and forming a secure channel by the terminal and the information server using the generated information server key.

In accordance with another aspect of the present invention, an apparatus for securing a media independent handover message transportation of a terminal supporting a handover between heterogeneous networks, includes: a wireless interface unit providing an interface accessible to heterogeneous networks; a media independent handover function supporting a handover between heterogeneous networks and transferring network state information generated in a lower device driver to a upper layer; a connection manager exchanging a message about the handover between heterogeneous networks with the media independent handover function; and a secure protocol controller performing an authentication procedure with an access router to generate a master session key and forming a secure channel with an information server using an information server key generated as the generated master session key is transferred to the information server.

When using a method for securing an MIH message of the present invention, an MIH message is transmitted and received through a secure channel at a handover between Heterogeneous Networks. Accordingly, the MIH message may be protected from external attack. In detail, in a secure method using IPSec, the IPSec is a most general secure protocol in transmitting and receiving a message through IP, and has an advantage in that a secure key is automatically formed using IKEv2. Further, a secure method using DTLS has advantages in that the DTLS is an application layered protocol, needs not correction of kernel and does not depend on other transmission protocols. In addition, in a secure method using MIHSec, since a key formed at a layer 2 is used in an MIH authentication step being a layer 3 not to repeatedly create a secure key, a security procedure may be rapidly performed.

### BRIEF DESCRIPTION OF THE DRAWINGS

The objects, features and advantages of the present invention will be more apparent from the following detailed description in conjunction with the accompanying drawings, in which:

FIG. 1 is a view illustrating the concept of a framework of a general MIH;

FIG. 2 is a view illustrating a network structure including a general MIH service;

FIG. 3 is a scheme diagram illustrating a procedure of exchanging MIH messages to handover a terminal to a Heterogeneous Network based on MIH;

FIG. 4 is a view illustrating the concept of a secure framework of an MIH according to an embodiment of the present invention;

FIG. 5 is a view illustrating an MIH message transportation model applied to the present invention;

FIG. 6 is a scheme diagram illustrating a method for securing MIH message transportation using IPSec/IKEv2 during handover of a terminal;

FIG. 7 is a scheme diagram illustrating a procedure of forming a secure channel by a terminal with a serving MIHF;

FIG. 8 is a scheme diagram illustrating a method for securing MIH message transportation using a DTLS during handover of a terminal;

FIG. 9 is a scheme diagram illustrating a procedure of forming a secure channel by a terminal with a serving MIHF and a DTLS;

FIG. 10 is a scheme diagram illustrating a procedure of forming a secure channel using IPSec/IKEv2 or DTLS and transmitting and receiving an MIH message;

FIG. 11 is a scheme diagram illustrating a method for securing MIH message transportation using MIHSec according to an embodiment of the present invention;

FIG. 12 is a view illustrating a procedure of generating an MIH key by an access router and an information server using MIHSec according to an embodiment of the present invention;

FIG. 13 is a scheme diagram illustrating a method for securing MIH message transportation using MIHSec during handover of a terminal;

FIG. 14 is a view illustrating a secure extension header with respect to an MIHSec protocol according to an embodiment of the present invention; and

FIG. 15 is a view illustrating an MIH message header including a stack and a secure TLV of an MIH protocol according to an embodiment of the present invention.

### DETAILED DESCRIPTION OF EXEMPLARY EMBODIMENTS

A method for securing an MIH message according to the present invention is applicable to communication between MIH Point of Service (PoS) of an access network, an MIHF of a terminal, an MIHF of an information server, between the MIHF of a terminal and an MIH Inter Working Function (IWF) Broker, and between MIHFs of different access routers. However, the method for securing an MIH message according to the present invention is not limited thereto. The method for securing an MIH message according to the present invention is applicable to various types of entity exchanging message during Heterogeneous network handover.

Further, security protocols such as IPSecurity (referred to as ‘IPSec’ hereinafter), Datagram Transport Layer Security (DTLS), and MIHSecurity (referred to as ‘MIHSec’ hereinafter) may be used in the method for securing an MIH message according to the present invention. The IPSec is a security solution of an IP layer generally used in an Internet application, which is described in ‘RFC 2401’ in detail. The DTLS is a security solution of an application layer, which is described in ‘RFC 4347’ in detail. The MIHSec is a security protocol according to the present invention, which generates an MIH key to be used in securing MIB message transportation being a layer 3 using a security key MSK formed in an authentication step of a layer 2. A detailed description of the MIHSec will be given below.

It is assumed that a terminal according to an embodiment of the present invention is a Multi-Mode Terminal (MMT) including a plurality of wireless interfaces capable of accessing different types of a wireless network (heterogenous network).

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

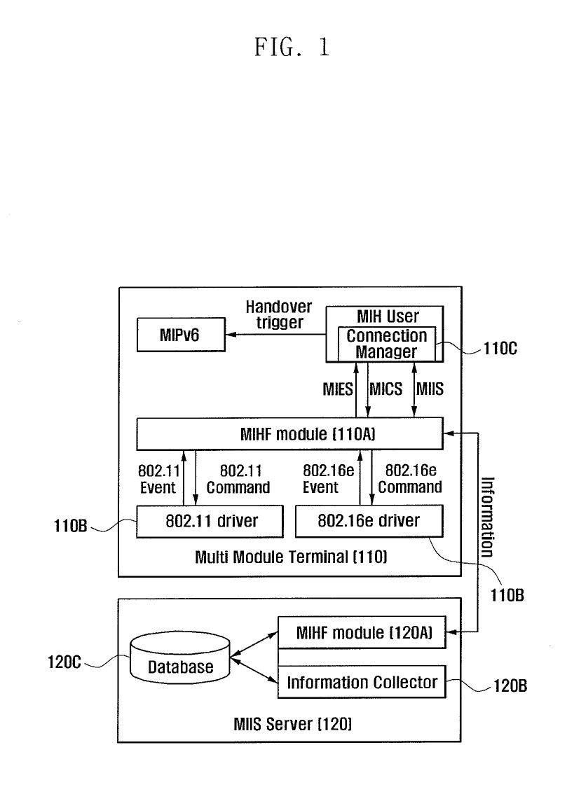

FIG. 1 is a view illustrating the concept of a framework of a general MIH.

Referring to FIG. 1, a framework of an MIH includes a terminal 110 and a Media Independent Information Service (MIIS) Server (referred to as ‘information server’).

The terminal 110 may include an MIHF 110A executing an MIH function, a plurality of wireless interfaces 110B supporting a handover between heterogeneous networks, and a connection manager 110C.

The MIHF 110A is a function entity for implementing an MIH technology. The MIHF 110A is located at an intermediate level between a protocol, application or management function pertaining to a layer 3 or more and a device driver pertaining to a layer 2 or less.

The MIHF 110A may transfer network state information generated in a lower device driver to an upper layer such that the upper layer optimizes performance according to mobility processing in a layer IP or more.

In an 802.21 standard, a service provided from the MIHF 110A is defined to be chiefly divided into an Event Service (ES), a Command Service (CS), and an Information Service (IS).

The MIH ES may transfer network state information generated by a lower device driver to a mobility management protocol to optimize performance according to mobility processing in a layer IP or more.

The MIH CS may support an interface capable of controlling an upper device driver in an upper application and mobility management protocol to change a network connection state in the upper application and mobility management protocol or query state information of a network.

The MIH IS provides information regarding various heterogeneous networks adjacent to a currently located network of a terminal. To do this, an 802.21 standard defines the information server 120 managing information about a heterogeneous network. The information server 120 will be explained below.

A plurality of wireless interfaces 110B provides an interface capable of accessing different types of network such that the terminal 110 may perform a handover between heterogeneous networks. FIG. 1 shows a wireless interface type based on 802.11, 802.16. However, the present invention is not limited thereto.

The connection manager 110C exchanges messages with respect to the MIH ES, the MIH CS, and the MIH IS with the MIHF 110A. Further, the connection manager 110C triggers a mobility management protocol (e.g., MIPv6) based on the message to manage a handover procedure.

The information server 120 collects and manages an identification, a Media Access Control (MAC) address and an IP address of a wireless access point adjacent to a heterogeneous network and an IP router, and network information for an operation company of a corresponding network and provides them to the terminal 110 or a network device. The information server 120 includes an MIHF module 120A, an information collector 120B, and a database 120C.

Functions of the MIHF module 120A of the information server 120 are identical to those of the MIHF module 110A of the multi module terminal 110. In other words, the MIHF module is located independently from the terminal and respective network entities, and supports a handover between heterogeneous networks.

The information collector 120B collects an identification, a Media Access Control (MAC) address and an IP address of a wireless access point adjacent to a heterogeneous network and an IP router, and network information for an operation company of a corresponding network, and stores them to the database 120C.

As illustrated in FIG. 1, a conventional MIH framework does not consider a method for securing MIH message transportation. Accordingly, upon transportation of the MIH message, there is a problem that it may be exposed to external attack.

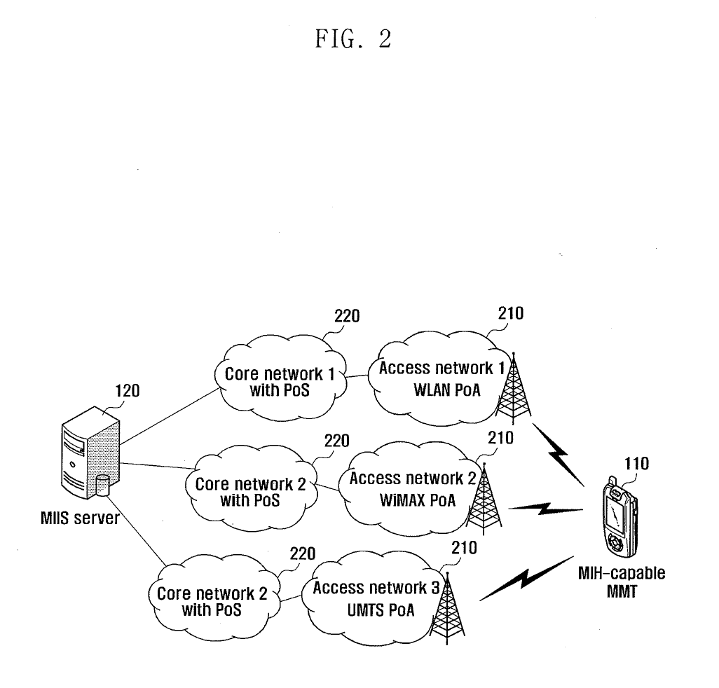

FIG. 2 is a view illustrating a network structure including a general MIH service.

The terminal 110 may connect with a Point of Attachment (referred to as ‘PoA’ hereinafter) 210 with respect to an access network of a layer 2 through a plurality of wireless interfaces. FIG. 2 illustrates a Wireless Local Area Network (WLAN), a Worldwide Interoperability for Microwave Access (Wimax), and a Universal Mobile Telecommunications System (UMTS) as an access network. However, the present invention is not limited thereto.

Each of the access networks provides at least one MIH Point of Service (referred to as ‘PoS’ hereinafter 220.

The information server 120 is located at one side of the foregoing network and provides information of neighboring networks.

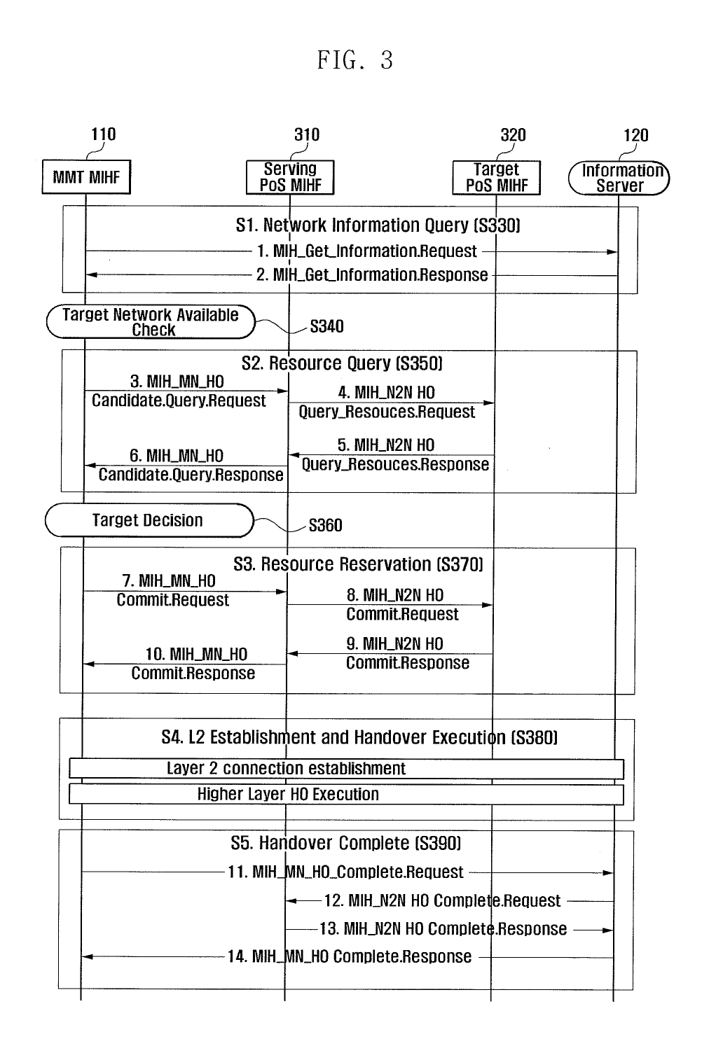

FIG. 3 is a scheme diagram illustrating a procedure of exchanging MIH messages to handover a terminal to a Heterogeneous Network based on MIH.

An MIH handover procedure includes a step (S330) of acquiring information about neighboring networks, a step (S340) of confirming available target networks, a step (S350) of checking available resources with respect to target networks, a step (S360) of determining a target network, a step (S370) of preparing a target network resource according to selection of the target network, a step (S380) of performing a handover that secures connection of a layer 2 and updates an IP address related to a layer 3, and a step (S390) of informing execution completion of the handover to release a resource used in a previous network.

In summary, the terminal 110 checks a resource availability state of neighboring target networks 320 to determine whether there is a target network capable of satisfying quality of a service (e.g., delay, bandwidth, etc.) provided from a current serving network 310. A user selects a final target network from candidate target networks according to a user profile and a handover rule, and prepares a resource for the terminal 120 to perform a handover between heterogeneous networks. If it is confirmed that the handover is performed, the user releases a resource used in the previous network.

The MIH handover procedure is described in an IEEE802.21 standard document, and thus a detailed description is omitted in the present invention.

FIG. 1 is a view illustrating the concept of a secure framework of an MIH according to an embodiment of the present invention.

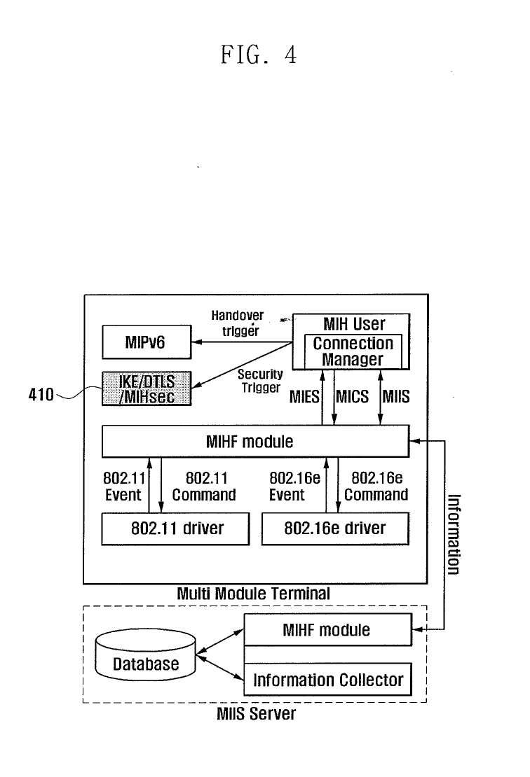

The MIH security framework shown in FIG. 4 is a structure in which a security protocol controller (referred to as ‘security protocol’) 410 is added to the MIH framework of FIG. 1. In an embodiment of the present invention, protocols such as IPSec, DTLS, and MIHSec may be used to secure MIH message transportation.

In an embodiment of the present invention, the security protocol 410 may secure MIH message transportation using IPSec/IKEv2 410.

The IPSec is a protocol developed to protect Internet Protocol (IP), which provides a security service such as Confidentiality, Integrity, Access Control, and Data Source Authentication. An encryption algorithm and key values necessary for defining the security service refer to a Security Association (SA) of the IPSec. Meanwhile, a protocol automatically setting the SA is Internet Key Exchange (IKE).

Further, in another embodiment of the present invention, the security protocol 410 may secure the MIH message transportation using the DTLS 410.

The DTLS is a protocol providing communication privacy with respect to a datagram protocol. The DTLS is designed to be executed in an application space without a modification request to kernel. The basic concept of the DTLS is Transport Layer Security (TLS) for a datagram. A reason why the TLS is applied to a datagram environment untouched is because data packets may be lost. Since the TLS does not expect loss of the data packets, the concept of the DTLS is introduced to perform a security procedure for the datagram. Concrete contents of the DTLS are described in ‘RFC 4347’, and thus a detailed description is omitted.

In a further embodiment of the present invention, the security protocol may secure MIH message transportation using MIHSec.

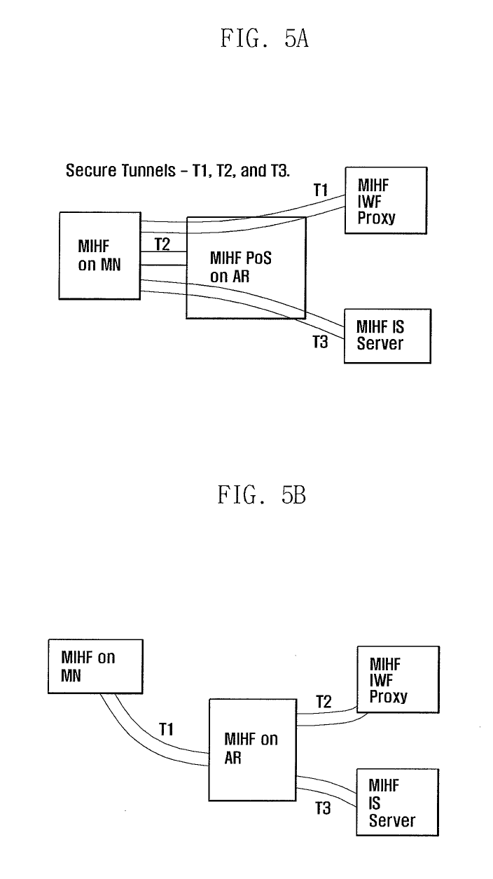

The MIHSec is an MIH message transportation security protocol according to the present invention. In the MIHSec a master session key (referred to as ‘MSK’ hereinafter) created in an authentication step of a layer 2 is used to create an MIH transportation security key (referred to as ‘MIH key’ hereinafter) of a layer 3. In other words, the security protocol 410 performs an authentication procedure with an access router to generate the MSK. The security protocol 410 may form a secure channel with the information server using an information server key generated by the information server as the generated MSK is transferred to the information server. Moreover, the security protocol may form a secure channel with the access router using a peer key generated by the access router using the MSK. FIG. 5 is a view illustrating an MIH message transportation model applied to the present invention.

A security module used in a security architecture may be generally divided into an End-to-end Protection model and an Endpoint-to-Security Gateway Protection model.

As shown in FIG. 5(a), the end-to-end Protection model forms secure channels T1, T2, and T3 between a terminal and each MIH service endpoint of a network before starting exchange of an MIH message. In this case, a source of the secure channel may be the terminal 110 and a destination thereof may be an IWF, the information server 120, and a PoS. Here, the IWF is a function entity providing a Proprietary Function between an MIH service and a certain access network.

Meanwhile, as shown in FIG. 5b, the Endpoint-to-Security Gateway Protection model forms a secure channel between the terminal 110 and an access router (referred to as ‘AR’ or ‘PoA’ hereinafter) before starting exchange of the MIH message. In this case, a source of a secure channel is the terminal 110 and a destination thereof is an AR. Further, the AR forms a separate secure channel between the AR and each MIH entity of a network. That is, all secure channels are formed through the AR.

Hereinafter, the method for securing MIH message transportation according to the present invention will be described based on the End-to-end Protection. Referring to the End-to-end Protection model, a method for securing MIH message transportation with respect to an Endpoint-to-Security Gateway Protection will be apparent to a person having ordinary skill in the art.

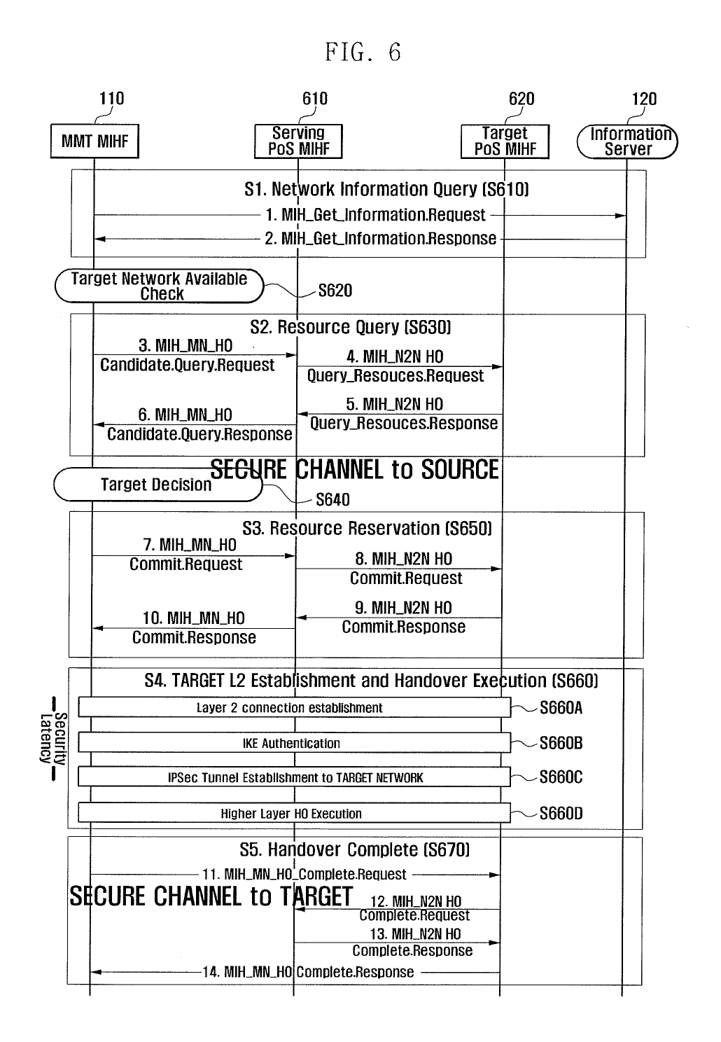

FIG. 6 is a scheme diagram illustrating a method for securing MIH message transportation using IPSec/IKEv2 during handover of a terminal 110.

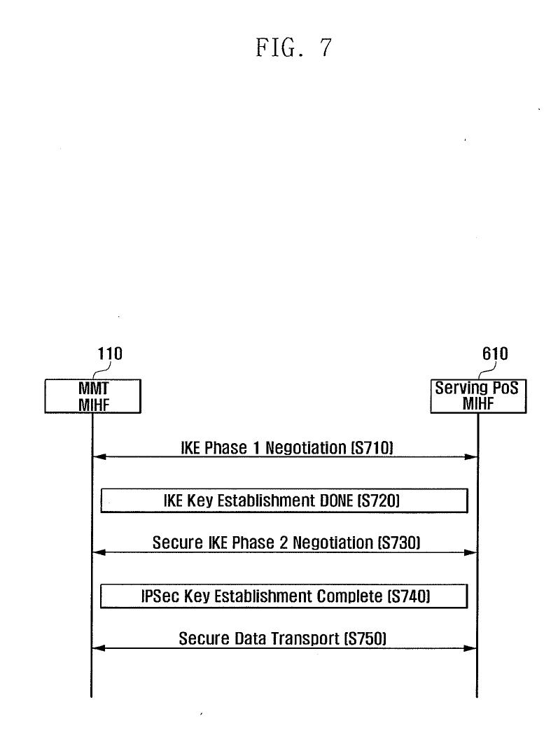

When firstly accessing an MIHF 610 of a service PoS (referred to as ‘serving MIHF’), a terminal 110 forms a secure channel using IPSec/IKEv2. FIG. 7 illustrates a procedure forming a secure channel by the terminal 110 with the service MIHF 610.

Because a procedure forming a secure channel using IPSec/IKEv2 is described in ‘RFC 2401’, it is simply explained in the present invention. An IKE Phase 1 Negotiation is firstly performed between a terminal 110 and a serving MIHF (S710). If the IKE Phase 1 Negotiation is completed, an IKE key Establishment is done (S720). Next, a Secure IKE Phase 2 Negotiation is performed (S730). If the Secure IKE Phase 2 Negotiation is completed, an IPSec Key Establishment is Complete (S740). Subsequently, secure data may be transmitted and received through a secure channel (S750).

Referring back to FIG. 6, after a secure channel is formed between the terminal 110 and the serving MIHF 610, the terminal 110 may determine whether a handover is necessary. Accordingly, the terminal 110 acquires information about a neighboring network (S610), confirms an available target network (S620), and checks available resources for target networks (S630). Next, the terminal 110 determines a target network (S640), and prepares a target network according to selection of the target network (S650). Subsequently, the terminal 110 establishes layer 2 connection and performs a handover with the target network (S660).

In an embodiment of the present invention, the terminal 110 may perform an MIH message transportation security procedure with an MIHF 620 of a target PoS (referred to as ‘target MIHF’) using IPSec/IKEv2 protocols (S660).

In detail, the terminal 110 establishes layer 2 connection with the target MIHF 620 (S660A). Next, the terminal 110 performs an authentication procedure with the target MIHF 620 using IPSec/IKEv2 protocols (S660B).

If the authentication procedure is complete, an IPSec secure channel is formed between the terminal 110 and the target network (660C). Subsequently, an MIH message is transmitted and received between the terminal 110 and the target MIHF 620 through the IPSec secure channel.

Next, the terminal 110 performs a handover to the target MIHF 620 in an upper layer (S660D) and informs handover performing completion to release a resource used in the serving network (S670).

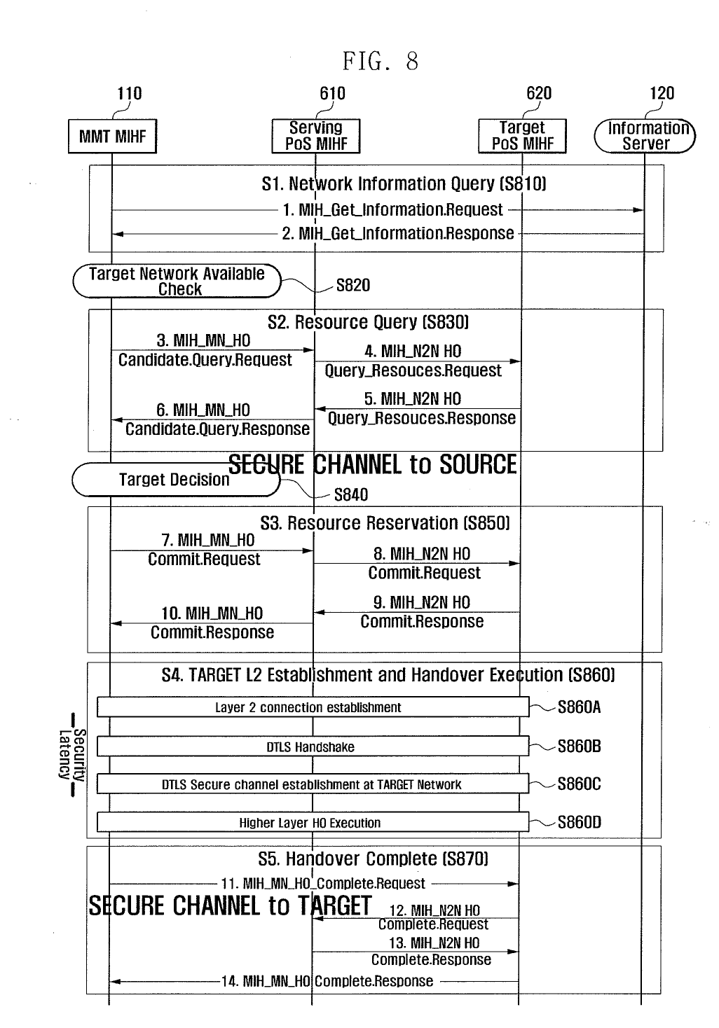

FIG. 8 is a scheme diagram illustrating a method for securing MIH message transportation using a DTLS during a handover of a terminal 110.

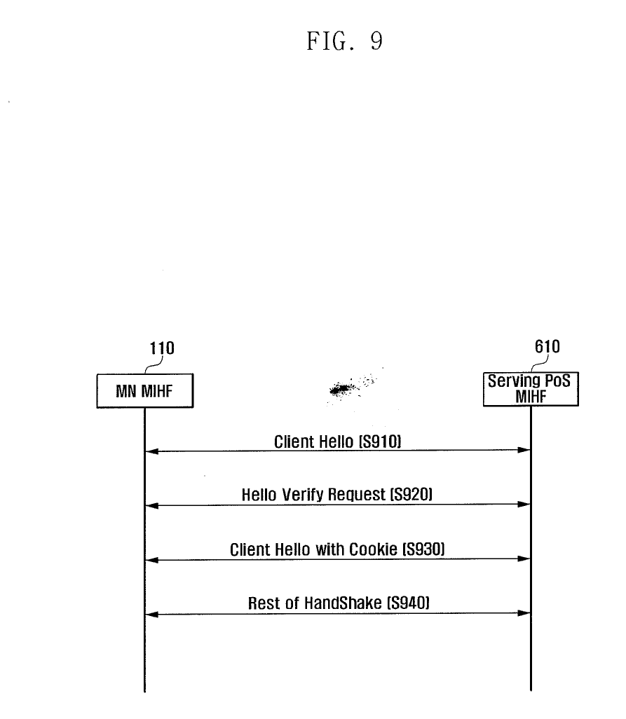

When firstly accessing a serving MIHF 610, a terminal 100 forms a secure channel using DTLS. FIG. 9 illustrates a procedure forming the secure channel by the terminal 110 with the serving MIHF 610 using the DTLS.

Since a procedure forming the secure channel using the DTLS is described in ‘RFC 4347’, it is simply explained in the present invention. A terminal 110 firstly transmits a Client Hello message to a serving MIHF 610 (S910). Accordingly, the serving MIHF 610 transmits a Hello Verify Request to the terminal 110 as a response thereto (S920). Next, the terminal 110 transmits Client Hello with Cookie to the serving MIHF 610 (S930). Subsequently, a Rest of Handshake is performed between the terminal 110 and the serving MIHF 610 (S940).

Referring back to FIG. 8, after the secure channel is formed between the terminal 110 and the serving MIHF 610, the terminal 100 may determine whether a handover is necessary. Accordingly, the terminal 110 acquires information about a neighboring network (S810), confirms available target networks (S820), and checks available resources for target networks (S830). Next, the terminal 110 determines a target network (S840), and prepares a target network resource according to selection of the target network (S850). Subsequently, the terminal 110 establishes layer 2 connection and performs a handover with the target network (S860).

In an embodiment of the present invention, the terminal 110 may perform an MIH message transportation procedure with the target MIHF 620 using DTLS (S860).

In detail, the terminal 110 establishes layer 2 connection with an MIHF 620 of a target PoS (S860A). Next, the terminal 110 performs an authentication procedure with the target MIHF 620 using DTLS (S860B).

If the authentication procedure is complete, a secure channel (DTLS channel) is formed between the terminal 110 and the target network (S860C). Next, an MIH message is transmitted and received between the terminal 110 and the target MIHF 620 through the DTLS secure channel.

Next, the terminal 110 performs a handover to the target MIHF 620 in an upper layer (S680D) and informs handover performing completion to release a resource used in the serving network (S870).

The following is a description of a procedure for securing MIH message transportation using an MIHSec protocol.

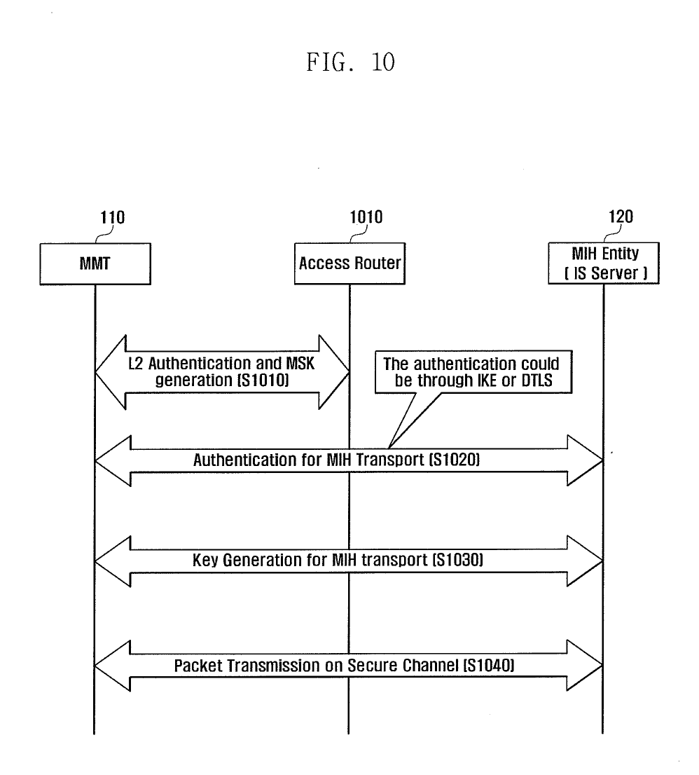

First, FIG. 10 illustrates a procedure forming a secure channel using the foregoing IPSec/IKEv2 or DTLS and transmitting and receiving an MIH message.

First, a terminal 110 firstly performs an authentication procedure with an access router 1010 at a layer 2 to generate an MSK (S1010). In this case, an Extended Authentication Protocol (referred to as ‘EAP’ hereinafter) may be used as a security protocol for generating the MSK. The generated MSK is used to form the secure channel between the terminal 110 and the access router 1010.

In this case, the generated MSK is for a secure channel formed between the terminal 110 and the access router 1010 at a layer 2, and is shared by only the terminal 110 and the access router 1010. Accordingly, the terminal 110 should perform a separate authentication procedure with an MIH entity at a layer 3 to transport an MIH message through another entity and a secure channel.

Accordingly, the terminal 110 performs an authentication procedure for MIH message transportation with an optional MIH entity at a layer 3 (S1020). Hereinafter, it is assumed that the MIH entity is an information server. If the authentication procedure is performed, a key to be used to secure MIH message transportation, namely, an MIH key is generated. The MIH includes an Integrity Key and a Cipher Key. The generated MIH key is used to form a secure channel between the terminal 110 and the information server 120.

As illustrated in FIG. 10, the terminal 110 should separately perform an authentication step of a layer 2 and an authentication step of a layer 3 (namely, authentication step at an MIH level) to form a secure channel with an access router 1010 and an information server 120, respectively. Accordingly, upon triggering a handover, there may be a danger of being an obstacle in performing a rapid handover.

In the present invention, to remove the dangerous factor, the terminal 110 performs one authentication procedure with the access router 1010 at a layer 2, and suggests an MIHSec security protocol to generate an MIH key at a layer 3 (namely, MIH level) using the MSK generated in the authentication procedure.

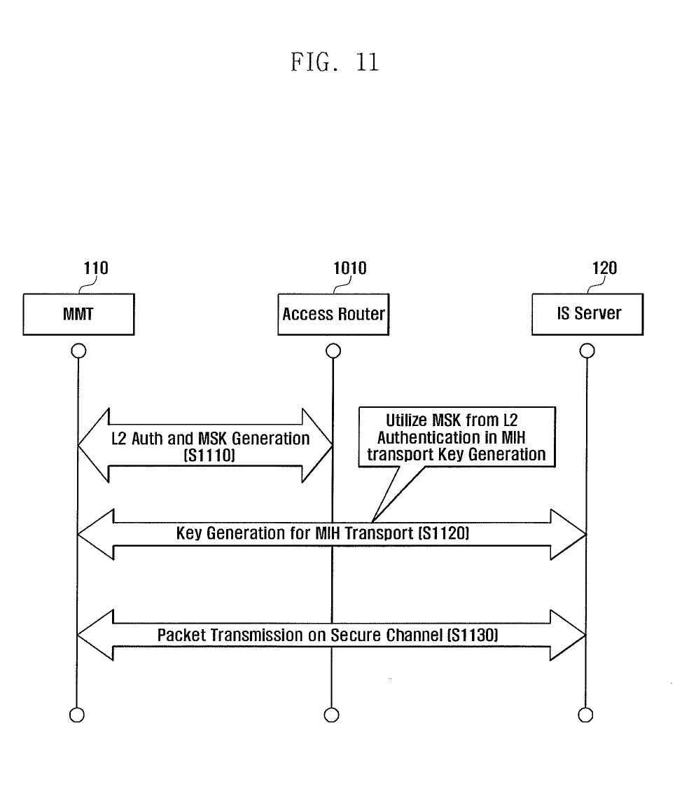

FIG. 11 is a scheme diagram illustrating a method for securing MIH message transportation using MIHSec according to an embodiment of the present invention.

First, the terminal 110 may perform an authentication procedure of a layer 2 with an access router 1010 (S1110). If the authentication procedure is performed, an MSK is generated. Accordingly, the access router 1010 transports the generated MSK and an MAC address of the terminal 110 to the information server 110.

Next, the access router 1010 generates a peer key using the MSK, and the information server 120 generates an information server key using the MSK (S1120).

The peer key is used to form a secure channel between the terminal 110 and the access router 1010 (S1130). The information server key is used to form a secure channel between the terminal 110 and the information server 120.

Accordingly, in the MIHSec of the present invention, because an MIH key is generated using an MSK generated in an authentication procedure of a layer 2, there is not a need for a separate authentication procedure at an MIH level.

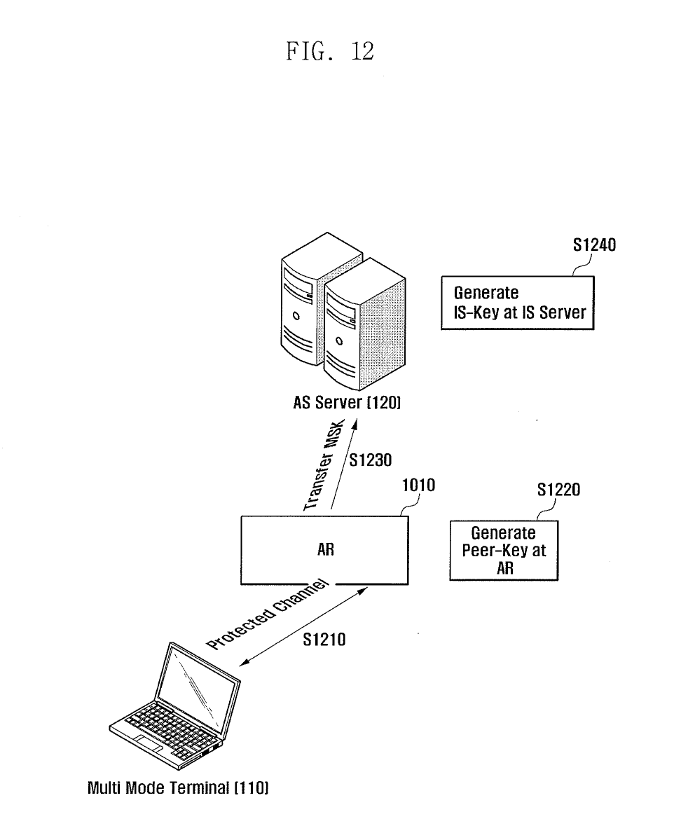

FIG. 12 is a view illustrating a procedure of generating an MIH key by an access router 1010 and an information server 120 using MIHSec according to an embodiment of the present invention.

First, a terminal 110 may perform an authentication procedure of a layer 2 with an access router 1010 using an EAP (S1210). If the authentication procedure is performed, an MSK is generated. Subsequently, the access router 1010 generates a peer key to be used in securing MIH message transportation with the terminal 110 (S1220).

In this case, an algorithm generated by the access router 1010 is illustrated in a following 1.

TABLE 1
Key_Generation_Algorithm_in_MIHPeer( )Begin:Get the MSK
key of EAPUse the keyed-md5 as Pseudo Random Function
for generating the Peer-KeyPeer-Key = Keyed-md5(MSK,
MAC-Peer, MAC-PoA)// The inputs to the prf are MAC
address of MMT and MAC address of PoA The result of
keyed-md5 is Peer-Key Peer-Key is a 128 bit hash value
Use Peer-Key to generate the CK and IK Cipher Key=
prf(Peer-Key, “Peer”, 0)Integrity Key = prf(Peer-Key,
“Peer”, 1)// The 0 and 1 in the prf function indicate
whether the key generated is the CK or the IKEnd

The table 1 is described. An access router 1010, namely, a PoA performs an EAP procedure with the terminal 110 to generate an MSK. Further, the access router 1010 executes an encryption algorithm using an MAC address of the terminal 110 and an MAC address thereof. Accordingly, a peer key for securing MIH message transportation between the terminal 110 and the access 1010 is generated. In other words, the peer key is an output value of a pseudo-random function having an MSK, an MAC address of a terminal, and an MAC address of an access router as inputs. The peer key has a hash value of 128 bits.

The access router 1010 generates a cipher key and an integrity key using the peer key. The terminal 110 and the access router 1010 secure an MIH message transportation procedure using the cipher key and the integrity key.

Further, the access router 1010 transports an MSK generated in the authentication procedure and an MAC address of the terminal 110 to the information server 120 (S1230). Accordingly, the information server 120 generates an information server key to be used in securing MIH message transportation with the terminal 110.

In this case, an algorithm generated by the information server 120 is illustrated in a following 2.

TABLE 2

Key_Generation_Algorithm_in_MIHServer( )Begin:Get the
MSK key of EAPUse the keyed-md5 as Pseudo Random
Function for generating the IS-KeyIS-Key= Keyed-
md5(MSK, ISServer-IPAddress, MAC-Peer)//The inputs to
the prf are IP Address of the IS server and MAC address
of MMT The result of keyed-md5 is IS-Key Peer-Key is a
128 bit hash value Use IS-Key to generate the CK and
IKs between the MMTand the IS server Cipher Key =
prf(IS-Key, “IS-Server”, 0)Integrity Key = prf(IS-Key,
“IS-Server”, 1)//The 0 and 1 in the prf function
indicate whether the key generated is the CK or the IK.
End:

The table 2 is explained. The information server 120 receives an MSK and an MAC address of the terminal 110 from the access router 1010. Accordingly, the information server 120 performs the encryption algorithm using the MAC address of the terminal 110 and an IP address of the information server 120. Accordingly, an information server key for securing MIH message transportation between the terminal 110 and the information server 120 is generated.

In other words, the information server key is an output value of a pseudo-random function having the MSK, an IP address of the information server, and an MAC of the terminal as inputs. The information server key has a hash value of 128 bits.

The information server 120 generates a cipher key and an integrity key using the information server key. The terminal 110 and the information server 120 secure an MIH message transportation procedure using the cipher key and the integrity key.

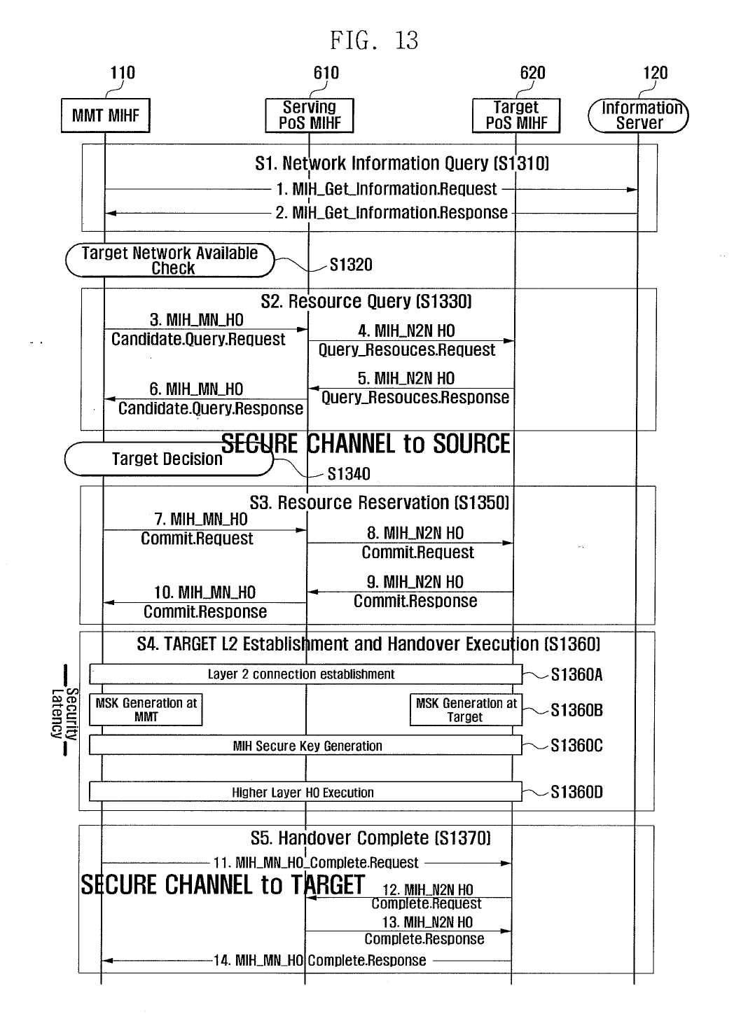

FIG. 13 is a scheme diagram illustrating a method for securing MIH message transportation using MIHSec during handover of a terminal 100.

When firstly accessing an MIHF 610, a terminal 110 forms a secure channel using MIHSec. A procedure forming a secure channel by the terminal 110 with the serving MIHF 610 and an information server 120 using MIHSec is illustrated in FIG. 12.

After forming the secure channel between the terminal 110 and the serving MIHF 610, the terminal 110 may determine whether a handover is necessary. Accordingly, the terminal 110 acquires information about a neighboring network (S1310), confirms available target networks (S1320), and checks available resources for the target networks (S1330). Further, the terminal 110 determines a target network (S1340), and prepares a target network resource according to selection of the target network (S1350). Next, the terminal 110 establishes layer 2 connection with the target network and performs a handover to the target network (S1360).

In an embodiment of the present invention, the terminal 110 may perform target MIHF 620 and MIH message transportation security procedure with the target MIHF 620 using MIHSec (S1360).

In detail, the terminal 110 establishes layer 2 connection with a target MIHF 620 (S1360A). If an authentication procedure due to EAP between the terminal 110 and the target MIHF 620 is performed, respective MSKs are generated in the terminal 110 and the target MIHF 620 (S1360B).

Accordingly, the terminal 110 and the target MIHF 620 generate an MIH key to be used in MIH message transportation using MIHSec of the present invention (S1360C). If the MIH key is generated, a secure channel (MIHSec channel) is formed between the terminal 110 and the target network.

Next, an MIH message is transmitted and received between the terminal 110 and the target MIHF 620 through the DTLS secure channel.

Subsequently, the terminal 110 performs a handover with a target MIHF 620 at an upper layer (S1360D), and informs handover performing completion to release a resource used in the serving network (S1370).

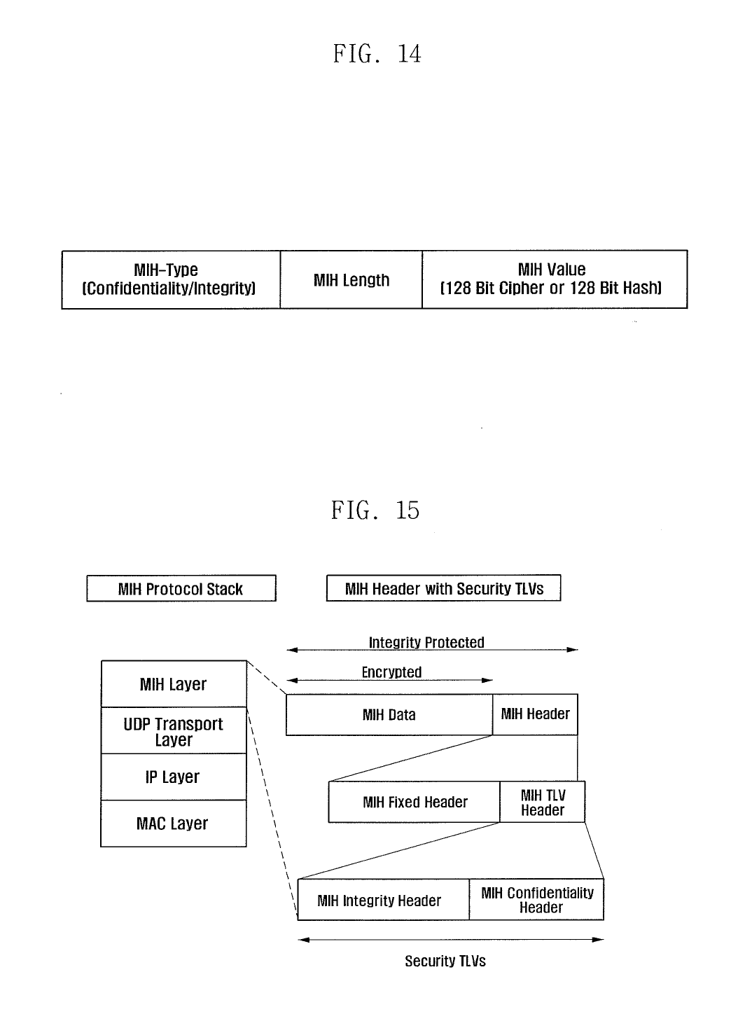

FIG. 14 is a view illustrating a secure extension header with respect to an MIHSec protocol according to an embodiment of the present invention.

There is a need to extend an MIH message header in order to secure MIH message transportation. That is why there is a need to determine whether security of an MIH message is set at an endpoint receiving an MIH message. Accordingly, there is a need to add two new TLVs (Type, Length, Value) to a conventional MIH message header. The two new TLVs consist of an encryption TLV and an Integrity TLV.

FIG. 14 shows an extension header of an MIH message according to the foregoing embodiment. As shown in FIG. 15, the extension header includes an MIH type indicating Confidentiality or Integrity, an MIH length indicating the length, and an MIH value indicating cipher or hash.

FIG. 15 is a view illustrating an MIH message header including a stack and a secure TLV of an MIH protocol according to an embodiment of the present invention.

First, an MIH layer of the present invention may be located at an upper layer of a UDP transmission layer. Further, a TLV header of the MIH header includes an MIH integrity header and an MIH Confidentiality header for transportation security.

A TLV included in the MIH integrity header and the MIH Confidentiality header is an MIH type, an MIH length indicating the length, and an MIH value indicating cipher or hash shown in FIG. 14.

As shown in FIG. 15, encryption is applied to MIH data and Confidentiality is applied to the MIH header and the MIH data on the whole.

In an embodiment of the present invention, when an MIH message from the terminal 110 is transported to the information server 120, an MIHF of the terminal 110 may firstly protect confidentiality and then protect integrity. Accordingly, the information server 120 firstly checks the integrity. Only if there is no abnormality in the integrity, the information server 120 checks the confidentiality. If there is an abnormality in the integrity or the confidentiality, the information server 120 drops a received MIH message.

As illustrated above, after forming a secure channel using a security protocol such as IPSec, DTLS, or MMIHSec, the present invention may transport an MIH message.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method for securing media independent handover message transportation, the method comprising:
performing an authentication procedure by a terminal with an access router to generate a master session key;
transmitting the generated master session key and address information of the terminal to an information server by the access router;
generating an information server key to be used in transmitting and receiving a message by the information server with the terminal using the received master session key and the address information of the terminal; and
forming a secure channel by the terminal and the information server using the generated information server key.

2. The method of claim 1, further comprising:
generating a peer key to secure the media independent handover message transportation by the access router using the generated master session key after generating the master session key; and
forming a secure channel by the terminal and the access router using the generated peer key.

3. The method of claim 2, wherein performing an authentication procedure is achieved at a layer 2.

4. The method of claim 2, wherein generating a peer key comprises inputting the master session key, the address information of the terminal, and address information of the access router in a pseudo-random function by the access router to generate the peer key.

5. The method of claim 2, wherein generating an information server key comprises inputting the master session key, the address information of the terminal, and IP address information of the information server in a pseudo-random function by the information server to generate the information server key.

6. The method of claim 2, wherein a media independent handover message encrypted using the peer key comprises a media independent handover integrity header and a media independent handover confidentiality header.

7. The method of claim 6, wherein the media independent handover integrity header and the media independent handover confidentiality header comprise a media independent handover type, a media independent handover length, and media independent handover value.

8. The method of claim 2, wherein a media independent handover message encrypted using the information server key comprises a media independent handover integrity header and a media independent handover confidentiality header.

9. The method of claim 8, wherein the media independent handover integrity header and the media independent handover confidentiality header comprise a media independent handover type, a media independent handover length, and a media independent handover value.

10. An apparatus for securing a media independent handover message transportation of a terminal supporting a handover between heterogeneous networks, the apparatus comprising:
a wireless interface unit providing an interface accessible to heterogeneous networks;
a media independent handover function supporting a handover between heterogeneous networks and transferring network state information generated in a lower device driver to a upper layer;
a connection manager exchanging a message about the handover between heterogeneous networks with the media independent handover function; and
a secure protocol controller performing an authentication procedure with an access router to generate a master session key and forming a secure channel with an information server using an information server key generated as the generated master session key is transferred to the information server.

11. The apparatus of claim 10, wherein the secure protocol controller controls the access router to generate a peer key to secure the media independent handover message transportation using the generated master session key after generating the master session key

12. The apparatus of claim 11, wherein the secure protocol controller controls generation of the master session key at a layer 2.

13. The apparatus of claim 11, wherein a media independent handover message transmitted and received through a secure channel formed by the information server or the access router comprises a media independent handover integrity header and a media independent handover confidentiality header.

14. The apparatus of claim 13, wherein the media independent handover integrity header and the media independent handover confidentiality header comprise a media independent handover type, a media independent handover length, and media independent handover value.
